(19) United States
(12) Patent Application Publication
(10) Pub. No.: US 2026/0035546 A1
(43) Pub. Date: Feb. 5, 2026

(54) CELLULOSE POROUS BODY AND TRANSPARENT HEAT INSULATING MEMBER

(71) Applicant: FUJIFILM Corporation, Tokyo (JP)

(72) Inventors: Ryoji HIMENO, Minamiashigara-shi (JP); Shinichi MORISHIMA, Minamiashigara-shi (JP); Satoshi KUNIYASU, Minamiashigara-shi (JP)

(73) Assignee: FUJIFILM Corporation, Tokyo (JP)

(21) Appl. No.: 19/358,458

(22) Filed: Oct. 15, 2025

Related U.S. Application Data
(63) Continuation of application No. PCT/JP2024/014979, filed on Apr. 15, 2024.

(30) Foreign Application Priority Data
Apr. 20, 2023 (JP) 2023-069387

(51) Int. Cl. C08L 1/02

(52) U.S. Cl. CPC C08L 1/02

(57) ABSTRACT

An object of the present invention is to provide a cellulose porous body having high transparency. The cellulose porous body according to the embodiment of the present invention includes a cellulose nanofiber and an antifreeze, and has a fiber diameter of 40 nm or less.

### CROSS-REFERENCE TO RELATED APPLICATIONS

This application is a Continuation of PCT International Application No. PCT/JP2024/014979 filed on Apr. 15, 2024, which claims priority under 35 U.S.C. § 119(a) to Japanese Patent Application No. 2023-069387 filed on Apr. 20, 2023. The above applications are hereby expressly incorporated by reference, in their entirety, into the present application.

### BACKGROUND OF THE INVENTION

### 1. Field of the Invention

The present invention relates to a cellulose porous body. Further, the present invention relates to a transparent heat insulating member including a cellulose porous body.

### 2. Description of the Related Art

Cellulose nanofibers (hereinafter, also referred to as “CNF”) are fibers produced by a pulverization treatment, a chemical treatment, and the like from a pulp or the like, which is a cellulose-based raw material. Since CNF is lightweight and has high strength, CNF is expected to be used in various applications. In addition, CNF is a natural material derived from a plant or a living organism, and is also attracting attention in terms of a small environmental load in a case of disposal or the like.

In addition, the porous body has been used for various applications due to the structure thereof, the specific surface area thereof, and the like. Here, it is expected that the cellulose porous body containing CNF has properties of being lightweight and having high strength.

In the production of the cellulose porous body containing CNF, a freeze-drying step may be applied in order to prevent aggregation of CNF.

For example, JP5827178B discloses a method of producing a cellulose porous body, in which a mixed solvent of water and an organic solvent, in which a concentration of the organic solvent in the mixed solvent is 2% to 40% by mass, is used as a dispersion medium of CNF, and a dispersion liquid of CNF is freeze-dried.

### SUMMARY OF THE INVENTION

Depending on the applications of the cellulose porous body containing CNF, transparency may be required.

As a result of examination on the cellulose porous body produced by the method described in JP5827178B, the present inventors have found that the transparency is not sufficient and further improvement is required.

Therefore, an object of the present invention is to provide a cellulose porous body having high transparency.

In addition, another object of the present invention is to provide a transparent heat insulating member.

The present inventors have completed the present invention as a result of intensive studies to solve the above-described problems. That is, the present inventors have found that the above-described objects can be achieved by the following configuration.

[1] A cellulose porous body comprising: a cellulose nanofiber; and an antifreeze, in which the cellulose porous body has a fiber diameter of 40 nm or less.

[2] The cellulose porous body according to [1], in which the antifreeze is antifreeze proteins.

[3] The cellulose porous body according to [2], in which the antifreeze proteins are derived from fish.

[4] The cellulose porous body according to any one of [1] to [3], in which thermal hysteresis of the antifreeze is 0.4° C. or higher.

[5] The cellulose porous body according to any one of [1] to [4], in which the cellulose porous body has a fiber diameter of 4 to 30 nm.

[6] The cellulose porous body according to any one of [1] to [5], in which a content of the antifreeze is 10% to 30% by mass with respect to a total mass of the cellulose porous body.

[7] A transparent heat insulating member comprising: the cellulose porous body according to any one of [1] to [6].

According to the present invention, it is possible to provide a cellulose porous body having high transparency.

In addition, according to the present invention, it is possible to provide a transparent heat insulating member.

### DESCRIPTION OF THE PREFERRED EMBODIMENTS

Hereinafter, the present invention will be described in detail.

The description of the configuration requirements described below is made on the basis of representative embodiments of the present invention, but it should not be construed that the present invention is limited to those embodiments.

Hereinafter, meaning of each description in the present specification will be explained.

Any numerical range expressed using “to” in the present specification refers to a range including the numerical values before and after “to” as a lower limit value and an upper limit value.

### <Cellulose Porous Body>

The cellulose porous body according to the embodiment of the present invention contains cellulose nanofibers (CNF) and an antifreeze, and has a fiber diameter of 40 nm or less.

It is considered that, since the cellulose porous body according to the embodiment of the present invention has a fiber diameter of 40 nm or less, the scattering of light is likely to decrease, and the transparency is excellent.

In the present specification, a small angle X-ray scattering (SAXS) method is employed as a method of measuring the fiber diameter of the cellulose porous body. Specifically, first, X-rays are incident on the cellulose porous body to obtain a pretreatment scattering curve. The scattering intensity in the pretreatment scattering curve is standardized based on the incident X-ray intensity transmitted through a beam stopper, and a standardized scattering curve for the cellulose porous body is obtained. In addition, a blank measurement is performed to obtain a standardized scattering curve for a medium (air) in the same manner as described above. A scattering curve I (q) for the fiber constituting the cellulose porous body is obtained by subtracting the standardized scattering curve for the medium from the standardized scattering curve for the cellulose porous body.

Here, q represents a scattering vector calculated by the following equation using a scattering angle 20.

$$q = 4 * π * ( sin ( θ ) ) / λ$$

(π: circumference ratio, 2θ: scattering angle [rad], λ: wavelength of X-rays [nm])

In a case where the scattering curve I(q) of the obtained cellulose porous body is plotted on a double-logarithmic graph, a region where the slope is a straight line appears. A Guinier plot related to the cross section is created for this region, and a scattering intensity average fiber diameter Dc is calculated by the following expression.

$$q * I ( q ) ∝ exp ( - ( D {c}^{2} * {q}^{2} ) / 16 )$$

The scattering intensity average fiber diameter Dc obtained by the expression shown above is defined as the fiber diameter of the cellulose porous body.

As described above, in the present invention, the fiber diameter of the cellulose porous body is 40 nm or less, and from the viewpoint that the transparency of the cellulose porous body is more excellent, the fiber diameter of the cellulose porous body is preferably 4 to 30 nm and more preferably 10 to 25 nm.

The fiber diameter of the cellulose porous body can be adjusted by, for example, the fiber diameter and the kind of CNF to be used, the kind of the antifreeze to be contained, the method of forming the cellulose porous body, and the like.

Hereinafter, CNF and the antifreeze, which are contained in the cellulose porous body, and the components which may be contained in the cellulose porous body will be described.

### [Cellulose Nanofiber]

The cellulose nanofibers (CNF) contained in the cellulose porous body according to the embodiment of the present invention are not particularly limited, and known CNF can be used.

Further, CNF denotes fibers obtained by forming a bundle formed of two or more cellulose molecular chains. The expression “forming a bundle formed of two or more cellulose molecular chain” denotes a state where two or more cellulose molecular chains are aggregated to form an aggregate called a microfibril.

CNF is usually obtained by treating fibers derived from a plant. The raw material of CNF is not particularly limited, and examples thereof include fibers derived from plants contained in wood, bamboo, hemp, jute, kenaf, cotton, beet pulp, potato pulp, agricultural product waste, cloth, and paper. The raw materials of CNF may be used alone or in combination of two or more kinds thereof.

CNF may be chemically modified, and from the viewpoint that the transmittance of the cellulose porous body is likely to be further increased, chemically modified CNF is preferable.

In the chemically modified CNF, some or all the groups in the cellulose molecular chain are changed by a chemical treatment. Examples of the cellulose molecular chain in the chemically modified CNF include cellulose molecular chains substituted with other functional groups such as a cellulose molecular chain in which some or all hydroxyl groups at the C6 position in a molecule are oxidized to an aldehyde group, a carboxyl group, or the like, a cellulose molecular chain in which some or all hydroxyl groups including a hydroxyl group at a position other than the C6 position are oxidized, a cellulose molecular chain which is esterified with nitric acid ester, acetic acid ester, phosphoric acid ester, or the like, and a cellulose molecular chain which is etherified with methyl ether, hydroxypropyl ether, carboxymethyl ether, or the like.

Here, more specific examples of the group to be introduced by chemical modification include a carboxy group, an acetyl group, a sulfate group, a sulfonic acid group, an acryloyl group, a methacryloyl group, a propionyl group, a propioloyl group, a butyryl group, a 2-butyryl group, a pentanoyl group, a hexanoyl group, a heptanoyl group, an octanoyl group, a nonanoyl group, a decanoyl group, a undecanoyl group, a dodecanoyl group, a myristoyl group, a palmitoyl group, a stearoyl group, a pivaloyl group, a benzoyl group, a naphthoyl group, a nicotinoyl group, an isonicotinoyl group, a furoyl group, an acyl group such as a cinnamoyl group, an isocyanate group such as a 2-methacryloyloxyethylisocyanoyl group, a methyl group, an ethyl group, a propyl group, a 2-propyl group, a butyl group, a 2-butyl group, a tert-butyl group, a pentyl group, a hexyl group, a heptyl group, an octyl group, a nonyl group, a decyl group, a undecyl group, a dodecyl group, a myristyl group, a palmityl group, an alkyl group such as a stearyl group, an oxirane group, an oxetane group, a thiirane group, and a thietane group.

Among these, it is preferable that the group to be introduced by chemical modification include at least a carboxy group.

The chemical modification of CNF can be performed by a typical method. That is, CNF can be chemically modified by reacting cellulose with a chemical modifier. As necessary, a solvent or a catalyst may be used, or heating, depressurization, or the like may be performed.

Examples of the kind of the chemical modifier include an acid, an acid anhydride, an alcohol, a halogenating reagent, an alcohol, an isocyanate, alkoxysilane, and a cyclic ether such as oxirane (epoxy). These may be used alone or in combination of two or more kinds thereof.

Examples of the acid include acetic acid, acrylic acid, methacrylic acid, propanoic acid, butanoic acid, 2-butanoic acid, and pentanoic acid.

In addition, after the chemical modification, it is preferable to sufficiently perform washing with water in order to terminate the reaction. It is preferable that the resultant is sufficiently washed with water and then substituted with an organic solvent such as an alcohol. In this case, the cellulose is substituted by being immersed in an organic solvent such as an alcohol.

The average fiber diameter of CNF is not particularly limited, but is preferably 1 to 100 nm, more preferably 2 to 50 nm, and still more preferably 2 to 10 nm. A cellulose porous body having a large specific surface area is likely to be obtained by using CNF having an average fiber diameter of 1 to 100 nm. In a case where the average fiber diameter thereof is 1 nm or greater, the single fiber strength of the nanofibers is increased, and the structure of the cellulose porous body is likely to be maintained.

Here, the average fiber diameter is calculated as follows. A transmission electron microscope (TEM) or a scanning electron microscope (SEM) is used to obtain an electron microscope image of the CNF. Random axes of two vertical and two horizontal lines are drawn on each of the obtained images, and the fiber diameter of the fiber intersecting the axes is visually read. In this case, the magnification is any of 5000 times, 10000 times, or 50000 times depending on the size of the fibers constituting the cellulose porous body. Further, the condition for the sample or the magnification is set as the condition that 20 or more fibers intersect with the axis. In this manner, images of at least three non-overlapping surface portions are captured with an electron microscope, and the values of the fiber diameters of the fibers intersecting each of the two axes are read. Therefore, information of a minimum of 20×2×3=120 strands of fibers can be obtained. The number average fiber diameter is calculated from the data of the fiber diameters obtained as described above, and is defined as the average fiber diameter of CNF. In addition, in a case where the length of the branched portion of the branched fiber is 50 nm or greater, the branched fiber is included in the calculation of the fiber diameter as one fiber.

In addition, the average fiber length of CNF is not particularly limited, but is preferably 0.01 to 20 m and more preferably 0.05 to 10 m.

Further, the average fiber length is calculated by casting a CNF dispersion liquid thinly on a substrate, freeze-drying the CNF dispersion liquid to obtain a sample, and observing the sample using an SEM. For the obtained observation image, 10 independent fibers are randomly selected per one image, and the fiber length is visually read. In this case, the magnification is any of 5000 times or 10000 times depending on the length of the fibers constituting the cellulose porous body. Further, the fibers whose start points and end points are included in the same image are used as the targets of the sample or the magnification. In this manner, images of at least 12 non-overlapping surface portions are observed with an SEM, and the fiber lengths are read. Therefore, information of at least 10×12=120 strands of fibers can be obtained. The number average fiber diameter is calculated from the data of the fiber diameters obtained as described above, and is defined as the average fiber diameter of CNF. In addition, in a case of the branched fiber, the length of the longest portion of the fiber is defined as the fiber length.

A method of adjusting the average fiber diameter of CNF is not particularly limited, and the average fiber diameter can be adjusted, for example, by a mechanical crushing method of adjusting the average fiber diameter by the treatment time of a ultra-high pressure homogenizer or a grinder to be used and the number of times of the treatment. In addition, in the chemical crushing method, the average fiber diameter can be adjusted by the kind of an oxidizing agent (for example, sodium hypochlorite), the concentration of a catalyst (for example, a TEMPO (2,2,6,6-tetramethyl-1-piperidinyloxy) catalyst), the reaction time, and the like.

A method of preparing CNF is not particularly limited, and a method of mechanically or chemically crushing the cellulose is preferable.

Examples of the method of the mechanical crushing include a method of defibrating an aqueous suspension or a slurry of a cellulose fiber-containing material by mechanically grinding or beating the suspension or the slurry with a refiner, a high-pressure homogenizer, a grinder, a uniaxial or multiaxial kneader, a beads mill, or the like. Examples of the mechanical treatment method include JP5500842B, JP5283050B, JP5207246B, JP5170193B, JP5170153B, JP5099618B, JP4845129B, JP4766484B, JP4724814B, JP4721186B, JP4428521B, WO11/068023A, JP5477265B, and JP2014-84434A.

On the other hand, as the chemical crushing method, for example, a cellulosic raw material is oxidized using an oxidizing agent in the presence of a N-oxyl compound and a bromide and/or an iodide, the oxidized cellulose is subjected to a wet micronization treatment to defibrate into nanofibers, and thus CNF can be produced. Examples of the chemical treatment method include methods described in JP5381338B, JP4981735B, JP5404131B, JP5329279B, JP5285197B, JP5179616B, JP5178931B, JP5330882B, JP5397910B, and the like.

In the cellulose porous body, the content of the CNF is preferably 80% by mass or greater, more preferably 90% by mass or greater, and still more preferably 95% by mass or greater with respect to the total mass of the cellulose porous body.

### [Antifreeze]

The antifreeze contained in the cellulose porous body according to the embodiment of the present invention is not particularly limited as long as the antifreeze has a function of suppressing water from being frozen, and a known antifreeze can be used.

Examples of the antifreeze include water-soluble polymers, saccharides, and antifreeze proteins. Among these, antifreeze proteins are preferable.

The antifreeze has an effect of suppressing growth of ice crystals, and can suppress coarsening of ice crystals. In a case where the cellulose porous body contains an antifreeze, for example, since ice crystals are not coarsened in a case where the cellulose porous body is formed by performing a freeze-drying step, the fiber diameter of the cellulose porous body to be obtained is reduced.

Examples of the water-soluble polymers as the antifreeze include polyvinyl alcohol, polyvinylpyrrolidone, and polyethylene glycol.

Examples of the saccharides as the antifreeze include glucose, maltose, sucrose, lactose, trehalose, and raffinose. In addition, polysaccharides extracted from fungi (for example, flammulina velutipes) are also preferable.

Examples of the antifreeze proteins include antifreeze glycoproteins and antifreeze proteins. The antifreeze proteins may have an effect of suppressing the growth of ice crystals, and the antifreeze proteins may be extracted from natural resources such as fish, plants, insects, and fungi and purified, may be produced by using fungal culture and a recombinant DNA technology, or may be produced by chemical synthesis. Among these, from the viewpoint that the transparency of the cellulose porous body is more excellent, the antifreeze proteins derived from fish are preferable.

There are various variations in the antifreeze proteins in terms of amino acid composition and higher-order structure.

Examples of the antifreeze proteins derived from fish include a type I antifreeze protein consisting of an α-helix structure mainly containing Ala (alanine) and having a molecular weight of about 3000 to 5000, a type II antifreeze protein consisting of a type C lectin-like structural motif and having a molecular weight of about 14000 to 24000, a type III antifreeze protein consisting of a spherical structure with a plurality of β-structures and having a molecular weight of about 7000, a type IV antifreeze protein consisting of a structure in which α-helix is bundled and having a molecular weight of about 12000, and an antifreeze protein (AFGP) composed of a repeating structure of three residues of -Ala-Thr (threonine)-Ala- and having a molecular weight of about 3000 to 24000, in which a side chain of the Thr residue is subjected to glycosylation modification.

In addition, preferred examples of the other antifreeze proteins include an antifreeze protein consisting of a 3-helix structure, having a molecular weight of about 7000 to 12000, and derived from an insect and an antifreeze protein derived from a kaiware radish sprout.

It is preferable that the antifreeze exhibits thermal hysteresis. The thermal hysteresis is defined by a value (° C.) obtained by subtracting a freezing temperature (° C.) from an equilibrium melting point (° C.) described below, and the expression that the thermal hysteresis is exhibited means that this value is 0.05° C. or higher. As the thermal hysteresis increases, the growth of ice crystals can be suppressed to a lower temperature, which indicates that the ability as the antifreeze is large.

The freezing temperature refers to a temperature at which the growth of ice crystals is started in a case where the aqueous solution containing an antifreeze is set to have a freezing point or lower of water.

The equilibrium melting point refers to a temperature at which melting starts in a case where the temperature of an aqueous solution containing a completely frozen antifreeze is increased.

The freezing point and the equilibrium melting point are measured by the method described in examples below.

The antifreeze exhibits thermal hysteresis, and the value thereof is preferably 0.1° C. or higher, more preferably 0.4° C. or higher, still more preferably 0.5° C. or higher, particularly preferably 0.9° C. or higher, and most preferably 1.0° C. or higher. The upper limit of the value of the thermal hysteresis is not particularly limited, and may be, for example, 10° C. In a case where the value of the thermal hysteresis of the antifreeze is in the above-described preferable ranges, the transparency of the cellulose porous body is more excellent.

In the cellulose porous body, the content of the antifreeze is preferably 1% to 40% by mass and more preferably 10% to 30% by mass with respect to the total mass of the cellulose porous body.

The antifreeze may be used alone or two or more kinds thereof may be used at the same time. In a case where two or more kinds of antifreezes are used at the same time, it is preferable that the total content thereof is in the above-described preferable ranges.

The content of the antifreeze may be calculated from the content of the antifreeze added during the preparation of the cellulose porous body, or the content thereof may be measured by extracting the antifreeze from the cellulose porous body. In a case where the content of the antifreeze is measured by extracting the antifreeze from the cellulose porous body, the antifreeze may be immersed in a solvent (for example, water) from which the antifreeze can be extracted, and the content of the antifreeze in the solvent containing the antifreeze may be measured by a known method.

### [Additive]

The cellulose porous body may contain an additive other than CNF and the antifreeze. Examples of the additive include a strength modifier.

Examples of the strength modifier include various latex emulsions such as acrylic latex, NBR-based latex, vinyl acetate-based latex, and olefin-based latex, and water-soluble polymers such as polyacrylamide, polyamide epichlorohydrin, polyvinyl alcohol, and starch.

The content of the additive is preferably 5% by mass or less and more preferably 1% by mass or less with respect to the total mass of the cellulose porous body. The cellulose porous body may contain no additives.

### [Method of Producing Cellulose Porous Body]

The method of producing the cellulose porous body is not particularly limited, but it is preferable to employ a method of producing a first cellulose porous body described below from the viewpoint that a cellulose porous body having more excellent transparency is likely to be obtained. In addition, a cellulose porous body having a large area can be obtained by employing the method of producing a first cellulose porous body.

### (Method of Producing First Cellulose Porous Body)

The method of producing the first cellulose porous body includes, in the following order, a step of preparing a CNF dispersion liquid in which CNF is dispersed and which contains an antifreeze, a step of gelling the CNF dispersion liquid to obtain a CNF wet gel, a step of replacing a solvent component in the CNF wet gel, and a step of freeze-drying the CNF wet gel to obtain a CNF aerogel.

Hereinafter, each step will be described.

First, a CNF dispersion liquid in which CNF is dispersed and which contains an antifreeze is prepared.

The CNF dispersion liquid in which CNF is dispersed and which contains an antifreeze is obtained, for example, by obtaining a CNF dispersion liquid using the method described in the section of the method of preparing CNF and adding the antifreeze to the dispersion liquid.

It is preferable that the dispersion medium in the CNF dispersion liquid contains water. The dispersion medium contains preferably 70% by mass or greater of water, more preferably 90% by mass or greater of water, and still more preferably 99% by mass or greater of water with respect to the total mass of the dispersion medium. Further, the dispersion medium in the CNF dispersion liquid may be water.

The content of CNF in the CNF dispersion liquid is preferably 0.001% to 5% by mass, more preferably 0.01% to 2% by mass, and still more preferably 0.1% to 1% by mass with respect to the total mass of the CNF dispersion liquid.

The content of the antifreeze in the CNF dispersion liquid can be adjusted to the above-described preferable content with respect to the total mass of the cellulose porous body to be formed. That is, the content of the antifreeze is adjusted to preferably 1% to 40% by mass and more preferably 10% to 30% by mass with respect to the total mass of the components other than the dispersion medium in the CNF dispersion liquid. Specifically, for example, the content of the antifreeze in the CNF dispersion liquid is preferably 0.0001% to 0.8% by mass and more preferably 0.001% to 0.4% by mass with respect to the total mass of the CNF dispersion liquid.

Further, the CNF dispersion liquid may contain the above-described additives.

Next, the CNF dispersion liquid is gelled to obtain a CNF wet gel.

The method of gelling the CNF dispersion liquid is not particularly limited, and examples thereof include a method of adding an acidic component or an alkaline component.

Among the examples, a method of adding an acidic component is preferable. In a case where the electrostatic repulsive force that contributes to the dispersion of CNFs in the CNF dispersion liquid is weakened by the addition of the above-described component, a network of CNFs is formed, and thus a CNF wet gel is obtained.

The acidic component to be added is not particularly limited, and examples thereof include an inorganic acid (for example, hydrochloric acid, sulfuric acid, nitric acid, or phosphoric acid), an organic acid (for example, methanesulfonic acid or tosylic acid), and a metal halide (for example, aluminum chloride). In addition, it is preferable that the acidic component is added to the CNF dispersion liquid in a state of a solution.

The amount of the acidic component to be added can be appropriately adjusted, but is, for example, preferably 0.01 to 5 mol/L with respect to the total volume of the CNF dispersion liquid after the addition of the acidic component.

In a case of adding the acidic component, it is also preferable that the acidic component is added without performing forced stirring and the mixture is allowed to stand.

Next, the solvent component in the CNF wet gel is replaced.

It is preferable that the solvent component in the CNF wet gel is replaced with a solvent in which fine crystals are precipitated in the subsequent freeze-drying treatment. Examples of the solvent in which fine crystals are precipitated include a mixed solvent. Among these, a mixed solvent of water and alcohol is preferable. It is preferable that the mixed solvent has a mixing ratio at which the components contained in the mixed solvent are precipitated as a eutectic in a case where the temperature is decreased. Examples of the alcohol include an alcohol that is miscible with water at any ratio, and preferred examples thereof include t-butyl alcohol. As the mixed solvent of water and t-butyl alcohol, a mixed solvent in which the content of water is 3% to 20% by mass with respect to the total mass of the mixed solvent is preferable, and a mixed solvent in which the content of water is 5% to 15% by mass with respect to the total mass of the mixed solvent is more preferable. Further, in the mixed solvent, it is preferable that the component other than water is t-butyl alcohol.

The solvent component in the CNF wet gel can be replaced by a known method, and for example, the CNF wet gel may be immersed in the mixed solvent. In this case, in order to promote the replacement, a shaking treatment may be performed.

Next, the CNF wet gel in which the solvent component has been replaced is freeze-dried to obtain a CNF aerogel.

The freezing may be carried out by a known method, but it is preferable that the CNF wet gel is rapidly cooled to be frozen from the viewpoint of reducing the size of crystals precipitated from the solvent contained in the CNF wet gel and obtaining a cellulose porous body having higher transparency. Examples of a method of rapidly cooling the CNF wet gel include a method of bringing the CNF wet gel into contact with a member cooled with liquid nitrogen.

Since the CNF wet gel contains the antifreeze, ice crystals are unlikely to grow during freezing, and the CNF wet gel is frozen while the dispersion state of CNF in the CNF wet gel is maintained.

The CNF wet gel is frozen, and the solvent component in the frozen CNF wet gel is sublimated. The solvent component may be sublimated while the environment of the frozen CNF wet gel is replaced with an environment at a freezing point lower than or equal to the freezing point of the solvent component. Further, in a case of sublimation of the solvent component, the pressure may be reduced to improve the sublimation rate.

The cellulose porous body according to the embodiment of the present invention is obtained by performing the above-described steps.

In addition, as another embodiment of the method of producing the cellulose porous body, the freeze-drying performed in the method of producing a first cellulose porous body may be replaced with a treatment of replacing the solvent component in the CNF wet gel using a supercritical fluid and drying the CNF wet gel.

### <Transparent Heat Insulating Member>

The transparent heat insulating member according to the embodiment of the present invention consists of the above-described cellulose porous body.

It is considered that since the transparent heat insulating member according to the embodiment of the present invention consists of a cellulose porous body, and the cellulose porous body has a fiber diameter of 3 to 40 nm, light scattering is likely to be small, and the transparency is excellent.

From the viewpoint of expanding the applications of the transparent heat insulating member, it is preferable that the transparent heat insulating member has a maximum length of 1000 mm or greater. The maximum length refers to the maximum length of the continuously formed cellulose porous body. For example, in a case where the transparent heat insulating member has a plate shape and the shape as viewed in a direction perpendicular to one surface of the plate is a rectangle, the maximum length of the transparent heat insulating member corresponds to a length of a long side of the rectangle. In addition, in a case where the transparent heat insulating member has a plate shape and the shape as viewed in a direction perpendicular to one surface of the plate is a circle, the maximum length of the transparent heat insulating member corresponds to a diameter of the circle.

The method of obtaining a transparent heat insulating member (cellulose porous body) having a maximum length of 1000 mm or greater is as described above. As the transparent heat insulating member, the cellulose porous body obtained by the above-described method may be used as it is, or the cellulose porous body may be processed into a desired shape to obtain a transparent heat insulating member.

The transmittance of the transparent heat insulating member is preferably greater than 70%, more preferably 75% or greater, and still more preferably 78% or greater. The transmittance of the transparent heat insulating member is usually less than 100%.

The transmittance of the transparent heat insulating member can be increased by reducing the fiber diameter of the cellulose porous body. The transmittance of the transparent heat insulating member is measured in conformity with the method described in examples. That is, it is preferable that the transmittance in a case where the thickness of the transparent heat insulating member is set to 5 mm is in the above-described ranges.

### <Applications>

The cellulose porous body (transparent heat insulating member) according to the embodiment of the present invention has high transparency and can be used for various applications. For example, the transparent heat insulating member can be suitably used for applications in which the heat insulation effects are exhibited. Specifically, the cellulose porous body (transparent heat insulating member) according to the embodiment of the present invention can be suitably applied to a window or a member thereof. Hereinafter, specific examples of the cellulose porous body (transparent heat insulating member) according to the embodiment of the present invention in a case of being applied to a window will be described, but the cellulose porous body (transparent heat insulating member) according to the embodiment of the present invention is not limited to the following specific examples.

### [Laminated Glass]

The cellulose porous body (transparent heat insulating member) according to the embodiment of the present invention can be applied as an interlayer film of laminated glass.

The configuration of the laminated glass is not particularly limited, and a known configuration can be used. For example, the number of glass plates used in the laminated glass may be 2 or more, 3 or more, or 4 or more.

In a case where the cellulose porous body (transparent heat insulating member) according to the embodiment of the present invention is used as an interlayer film of the laminated glass, the cellulose porous body is disposed between two or more glass plates used in the laminated glass. However, in a case where the number of glass plates is three or more, the cellulose porous body (transparent heat insulating member) according to the embodiment of the present invention may be disposed between each of the glass plates, or the cellulose porous body (transparent heat insulating member) according to the embodiment of the present invention may be disposed only between a set of glass plates.

In the case where the cellulose porous body (transparent heat insulating member) according to the embodiment of the present invention is used as an interlayer film of the laminated glass, a configuration (another layer) other than the cellulose porous body (transparent heat insulating member) according to the embodiment of the present invention may be provided between a set of glass plates. That is, the cellulose porous body (transparent heat insulating member) according to the embodiment of the present invention which is provided between the glass plates may be in direct contact with the glass plates or may be in contact with the glass plates through another layer.

Preferred examples of the other layers include one or more resin layers selected from the group consisting of polyvinyl butyral, polycarbonate, an ethylene-vinyl acetate copolymer, and polyethylene terephthalate.

As the other layers, an adhesive layer or a pressure-sensitive adhesive layer is also preferable.

In addition, other layers described in multi-layered glass below may be applied to the laminated glass.

As the glass plate used in the laminated glass, known glass can be used depending on the purpose thereof, and examples thereof include a transparent glass plate, a patterned glass plate, a wire glass plate, a wired glass plate, a reinforced glass plate, a heat ray reflecting glass plate, a heat ray absorbing glass plate, a Low-E glass plate, and various other glass plates. In addition, one or more of the glass plates used in the laminated glass may be formed of a glass substitute resin such as polycarbonate. The thickness of the glass plate can be appropriately selected depending on the purpose thereof.

The shape of the glass plate is not particularly limited and can be appropriately adjusted according to the applications. In addition, the glass plate may have a curved surface.

The laminated glass may have a known sealing structure. Examples of the sealing structure include a structure in which an outer edge portion of the laminated glass is sealed with a sealing material such as a resin.

### [Multi-Layered Glass]

The cellulose porous body (transparent heat insulating member) according to the embodiment of the present invention can be applied to multi-layered glass.

The multi-layered glass denotes glass including a gas layer between two or more glass plates. The gas layer is a layer consisting of a gas, and the gas contained in the gas layer may be air or an inert gas such as nitrogen gas or argon gas. Further, the gas layer may be under reduced pressure lower than the atmospheric pressure.

The number of glass plates included in the multi-layered glass may be 2 or more, 3 or more, or 4 or more.

In a case where the cellulose porous body (transparent heat insulating member) according to the embodiment of the present invention is applied to the multi-layered glass, the cellulose porous body (transparent heat insulating member) according to the embodiment of the present invention is disposed between a set of glass plates. However, in a case where the number of glass plates is three or more, the cellulose porous body (transparent heat insulating member) according to the embodiment of the present invention may be disposed between each of the glass plates or only between a set of glass plates.

In the case where the cellulose porous body (transparent heat insulating member) according to the embodiment of the present invention is applied to the multi-layered glass, the multi-layered glass may have one or more configurations (other layers) in addition to the cellulose porous body (transparent heat insulating member) according to the embodiment of the present invention.

Examples of the other layers include a light shielding layer and a heat insulating layer, in addition to the other layers described above.

The light shielding layer may be a layer having a low transmittance of at least a part of visible rays or a layer having a low transmittance of at least apart of ultraviolet rays. Examples of the light shielding layer include a metal vapor deposition film and a colored layer such as a coloring agent layer containing a coloring agent.

Examples of the heat insulating layer include a layer that reflects or absorbs infrared rays, and for example, a metal vapor deposition film, a polymer layer containing metal particles or metal oxide particles, and a dielectric multilayer film can be applied.

In addition, examples of the other layers also include a flame retardant layer. Examples of the flame retardant layer include a layer containing a flame retardant, and a known flame retardant can be applied as the flame retardant. Examples of the flame retardant include aromatic phosphoric acid ester, a phosphorus compound such as red phosphorus, a halogen-based compound such as chlorinated paraffin containing at least one of chlorine or bromine, an antimony compound such as antimony trioxide, a metal hydroxide such as aluminum hydroxide or magnesium hydroxide, and a nitrogen compound such as melamine cyanurate.

As the glass plate, a glass plate used in the above-described laminated glass can be applied.

In addition, the glass plate included in the multi-layered glass may be laminated glass. The laminated glass may be laminated glass including the cellulose porous body (transparent heat insulating member) according to the embodiment of the present invention described above.

The multi-layered glass may have a known sealing structure. Examples of the sealing structure include a sealing structure formed of a spacer installed at an outer edge portion of a set of glass plates and a sealing structure formed of a sealing material disposed between a spacer and a glass plate facing the spacer. With the sealing structure, a space formed by a set of glass plates and a spacer is the above-described gas layer. The spacer may include a drying material for the purpose of absorbing moisture in the gas layer.

In addition, the outer edge portion side of the glass plate with respect to the spacer may be sealed with another sealing material. Examples of the other sealing materials include a cured resin such as a polysulfide-based resin and a silicone-based resin.

In addition, the sealing structure may be composed of a frame that holds the multi-layered glass.

In a case where the cellulose porous body (transparent heat insulating member) according to the embodiment of the present invention is applied to the laminated glass and the multi-layered glass described above, the cellulose porous body (transparent heat insulating member) that is integrally molded may be applied, or a plurality of cellulose porous bodies (transparent heat insulating members) may be applied by being arranged in a plane direction of the glass plate. In addition, a plurality of cellulose porous bodies (transparent heat insulating members) may be applied by being laminated in a lamination direction of the glass plate.

Further, in the case where the cellulose porous body (transparent heat insulating member) according to the embodiment of the present invention is applied to the laminated glass and the multi-layered glass described above, the above-described flame retardant may be added to the cellulose porous body (transparent heat insulating member).

The laminated glass and the multi-layered glass described above can be suitably used, for example, as a window for a house or a window for a moving object such as a passenger car.

Further, the laminated glass and the multi-layered glass described above can transmit radio waves because the cellulose porous body (transparent heat insulating member) according to the embodiment of the present invention does not have conductivity. In a case where radio waves are intended to be transmitted, it is preferable to select a layer having no conductivity as the above-described other layers.

### EXAMPLES

Hereinafter, the present invention will be described in more detail with reference to examples.

Materials, used amounts, ratios, treatment details, treatment procedures, and the like shown in the following examples can be appropriately changed within a range not departing from the scope of the present invention. Accordingly, the scope of the present invention will not be restrictively interpreted by the following examples.

### Example 1

### [Step of Preparing Cellulose Nanofiber Aqueous Dispersion Liquid]

2.00 g of NBKP (bleached kraft pulp of coniferous wood, mainly consisting of fibers having a fiber diameter of greater than 1000 nm) in terms of dry mass, 0.025 g of TEMPO (2,2,6,6-tetramethylpiperidin-1-oxy radical), and 0.25 g of sodium bromide were dispersed in 150 ml of water, and a 13% sodium hypochlorite aqueous solution was added thereto such that the amount of sodium hypochlorite reached 5.00 mmol with respect to 1.00 g of NBKP, to start the reaction. During the reaction, a 0.50 mol/L sodium hydroxide aqueous solution was added dropwise to maintain the pH at 10. After the reaction for 2 hours, the reactant was filtered and sufficiently washed with water, thereby obtaining an oxidized cellulose slurry. 0.15% by mass of the oxidized cellulose slurry was subjected to a defibration treatment at 15,000 rpm for 5 minutes using a biomixer (BM-2, manufactured by NISSEI Corporation) and further subjected to a defibration treatment for 20 minutes using an ultrasonic disperser (model US-300E, manufactured by NISSEI Corporation). Thereafter, the coarse fibers were removed by centrifugation to obtain a transparent cellulose nanofiber aqueous dispersion liquid. The obtained cellulose nanofiber aqueous dispersion liquid was concentrated with a rotary evaporator until the concentration of solid contents reached 0.40%, and used in the subsequent steps.

Hereinafter, the cellulose nanofiber aqueous dispersion liquid having a concentration of solid contents of 0.40% will also be referred to as “cellulose nanofiber aqueous dispersion liquid A”.

A highly purified fish-derived type I antifreeze protein (manufactured by Nichirei Corporation, corresponding to antifreeze) was added to the cellulose nanofiber aqueous dispersion liquid A such that the content thereof was 0.08% with respect to the total mass of the cellulose nanofiber aqueous dispersion liquid A, and the mixture was stirred with a magnet stirrer.

### [Gelling Step]

500 g of the cellulose nanofiber aqueous dispersion liquid A to which the antifreeze protein had been added was poured into a petri dish having a size of 100 cm square, and 100 g of 1.0 M hydrochloric acid was gently allowed to flow down the wall surface and allowed to stand for 1 hour. The dispersion liquid was physically gelled, and the thickness thereof was 5 mm.

### [Solvent Replacement Step]

The solvent was replaced using a mixed solvent in which t-butyl alcohol and water were mixed at a mixing ratio of 90:10 in terms of mass ratio. The solvent was replaced by immersing the physical gel in a sufficient amount of a replacement solvent and slowly shaking the solution. Each replacement step was carried out for 4 hours, and replacement was performed 4 times or more.

### [Freeze-Drying Step]

The physical gel obtained in the solvent replacement step was sandwiched between upper and lower iron plates sufficiently cooled with liquid nitrogen (−196° C.) and was frozen. The solvent component of the frozen gel was sublimated using a vacuum dryer (manufactured by Tokyo Rikakikai Co., Ltd.) to obtain an aerogel (cellulose porous body).

### Example 2

A cellulose porous body was obtained in the same manner as in Example 1 except that a highly purified fish-derived antifreeze glycoprotein (AFGP) (manufactured by Nichirei Corporation) was used as the antifreeze.

### Example 3

A cellulose porous body was obtained in the same manner as in Example 1 except that a highly purified fish-derived type II antifreeze protein (AFGP) (manufactured by Nichirei Corporation) was used as the antifreeze.

### Example 4

A cellulose porous body was obtained in the same manner as in Example 1 except that a highly purified fish-derived type III antifreeze protein (manufactured by Nichirei Corporation) was used as the antifreeze.

### Example 5

A cellulose porous body was obtained in the same manner as in Example 1 except that the crudely purified fish-derived type I antifreeze protein (manufactured by Nichirei Corporation) was used as the antifreeze.

### Example 6

A cellulose porous body was obtained in the same manner as in Example 1 except that a crudely purified fish-derived antifreeze glycoprotein (AFGP) (manufactured by Nichirei Corporation) was used as the antifreeze.

### Example 7

A cellulose porous body was obtained in the same manner as in Example 1 except that a highly purified fish-derived type II antifreeze protein (AFGP) (manufactured by Nichirei Corporation) was used as the antifreeze.

### Example 8

A cellulose porous body was obtained in the same manner as in Example 1 except that a highly purified fish-derived type III antifreeze protein (manufactured by Nichirei Corporation) was used as the antifreeze.

### Example 9

A cellulose porous body was obtained in the same manner as in Example 1 except that a kaiware radish sprout-derived antifreeze protein (manufactured by Kaneka Corporation) was used as the antifreeze.

### Example 10

A cellulose porous body was obtained in the same manner as in Example 1 except that D(+) glucose (manufactured by FUJIFILM Wako Pure Chemical Corporation) was used as the antifreeze.

### Comparative Example 1

A cellulose porous body was obtained in the same manner as in Example 1 except that no antifreeze was added.

### Measurement and Evaluation

### [Measurement of Fiber Diameter]

The fiber diameters of the cellulose porous bodies of the examples and the comparative examples were measured by the above-described method.

### [Measurement of Thermal Hysteresis of Antifreeze]

The value of the thermal hysteresis of the antifreeze used in each example was measured as follows.

First, the powder of the antifreeze was dissolved in ultrapure water such that the amount thereof reached 5 parts by mass with respect to the total mass of the solution, and 4 μL of the solution (sample) was sandwiched between two sheets of cover glass. The sample was allowed to stand on a cooling stage of a cooling temperature range microscope system composed of a temperature controller (Linkam LNP94/2, TMS94), a sample cooling stage (Linkam THMSG 600), and a microscope (Nikon ECLIPSE E600). While the sample was observed with a microscope, the cooling stage was cooled until the entire surface of the sample was frozen, and the temperature at which the entire sample began to solidify was defined as the freezing temperature. Next, this sample having the entire surface being frozen was heated, and the temperature at which melting began was defined as the equilibrium melting point. A difference between the equilibrium melting point and the freezing temperature was defined as thermal hysteresis.

### [Evaluation of Transmittance]

The transmittances of the cellulose porous bodies of the examples and the comparative examples were measured using an ultraviolet-visible-near infrared spectrophotometer V-660 equipped with an automatic absolute reflectivity measuring unit ARMN-735 (manufactured by JASCO Corporation). Further, in the measurement, the sample was placed near an integrating sphere to measure the total light transmittance, and the transmittance was evaluated by the transmittance at 550 nm.

Further, the thicknesses of all the cellulose porous bodies of the examples and the comparative examples were 5 mm.

### Results

Table 1 lists the kind of antifreeze and the thermal hysteresis of the antifreeze used for preparing the cellulose porous body of each example and each comparative example, the fiber diameter, and the transmittance.

TABLE 1

| | | Thermal | Fiber | |
|---|---|---|---|---|
| | | hyster- | diam- | Trans- |
| | | esis | eter | mittance |
| | Antifreeze | (° C.) | (nm) | (%) |
| Example 1 | Highly purified fish-derived | 1.0 | 21 | 80 |
| | type I antifreeze protein | | | |
| Example 2 | Highly purified fish-derived | 0.9 | 22 | 78 |
| | antifreeze protein (AFGP) | | | |
| Example 3 | Highly purified fish-derived | 1.0 | 21 | 80 |
| | type II antifreeze protein | | | |
| Example 4 | Highly purified fish-derived | 0.9 | 22 | 78 |
| | type III antifreeze protein | | | |
| Example 5 | Crudely purified fish-derived | 0.5 | 27 | 76 |
| | type I antifreeze protein | | | |
| Example 6 | Crudely purified fish-derived | 0.5 | 27 | 76 |
| | antifreeze protein (AFGP) | | | |
| Example 7 | Crudely purified fish-derived | 0.4 | 28 | 75 |
| | type II antifreeze protein | | | |
| Example 8 | Crudely purified fish-derived | 0.4 | 28 | 75 |
| | type III antifreeze protein | | | |
| Example 9 | Kaiware radish sprout-derived | 0.1 | 32 | 72 |
| | antifreeze protein | | | |
| Example 10 | D(+) glucose | 0.1 | 32 | 72 |
| Comparative | None | — | 35 | 70 |
| Example 1 | | | | |

As shown in the results listed in Table 1, the cellulose porous body of Comparative Example 1, which did not contain the antifreeze, had low transparency as compared with each example.

Based on the comparison between Examples 9 and 10 and other examples, it was confirmed that in a case where the antifreeze was antifreeze proteins and the antifreeze proteins were derived from fish, the cellulose porous body had higher transparency.

Based on the comparison between Examples 9 and 10 and other examples, it was confirmed that in a case where the thermal hysteresis of the antifreeze was 0.4° C. or higher (preferably 0.5° C. or higher, more preferably 0.9° C. or higher, and still more preferably 1.0° C. or higher), the cellulose porous body had higher transparency.

Based on the comparison between Examples 9 and 10 and other examples, it was confirmed that in a case where the cellulose porous body had a fiber diameter of 4 to 30 nm, the cellulose porous body has higher transparency.

What is claimed is:

1. A cellulose porous body comprising:
a cellulose nanofiber; and
an antifreeze,
wherein the cellulose porous body has a fiber diameter of 40 nm or less.

2. The cellulose porous body according to claim 1,
wherein the antifreeze is antifreeze proteins.

3. The cellulose porous body according to claim 2,
wherein the antifreeze proteins are derived from fish.

4. The cellulose porous body according to claim 1,
wherein thermal hysteresis of the antifreeze is 0.4° C. or higher.

5. The cellulose porous body according to claim 1,
wherein the cellulose porous body has a fiber diameter of 4 to 30 nm.

6. The cellulose porous body according to claim 1,
wherein a content of the antifreeze is 10% to 30% by mass with respect to a total mass of the cellulose porous body.

7. A transparent heat insulating member comprising:
the cellulose porous body according to claim 1.

8. The cellulose porous body according to claim 2,
wherein thermal hysteresis of the antifreeze is 0.4° C. or higher.

9. The cellulose porous body according to claim 2,
wherein the cellulose porous body has a fiber diameter of 4 to 30 nm.

10. The cellulose porous body according to claim 2,
wherein a content of the antifreeze is 10% to 30% by mass with respect to a total mass of the cellulose porous body.

11. A transparent heat insulating member comprising:
the cellulose porous body according to claim 2.

12. The cellulose porous body according to claim 3,
wherein thermal hysteresis of the antifreeze is 0.4° C. or higher.

13. The cellulose porous body according to claim 3,
wherein the cellulose porous body has a fiber diameter of 4 to 30 nm.

14. The cellulose porous body according to claim 3,
wherein a content of the antifreeze is 10% to 30% by mass with respect to a total mass of the cellulose porous body.

15. A transparent heat insulating member comprising:
the cellulose porous body according to claim 3.
